(19) United States
(12) Patent Application Publication
(10) Pub. No.: US 2015/0219051 A1
(43) Pub. Date: Aug. 6, 2015

(54) FUEL INJECTORS WITH NON-COINED THREE-DIMENSIONAL NOZZLE OUTLET FACE

(71) Applicant: 3M INNOVATIVE PROPERTIES COMPANY, St. Paul, MN (US)

(72) Inventors: Barry S. Carpenter, Oakdale, MN (US); David H. Redinger, Oakdale, MN (US); Scott M. Schnobrich, Cottage Grove, MN (US); Ryan C. Shirk, Mendota Heights, MN (US)

(21) Appl. No.: 14/417,566

(22) PCT Filed: Aug. 1, 2013
(86) PCT No.: PCT/US2013/053193

§ 371 Date: Jan. 27, 2015

Related U.S. Application Data
(60) Provisional application No. 61/678,475, filed on Aug. 1, 2012.

(51) Int. Cl. F02M 61/18

(52) U.S. Cl. CPC F02M 61/18

(57) ABSTRACT

Nozzles and method of making the same are disclosed. The disclosed nozzles have an inlet face and a three-dimensional outlet face opposite the inlet face. The nozzles may have one or more nozzle through-holes extending from the inlet face to the outlet face. Fuel injectors containing the nozzle are also disclosed. Methods of making and using nozzles and fuel injectors are further disclosed.

### FIELD OF THE INVENTION

This invention generally relates to nozzles suitable for use in a fuel injector for an internal combustion engine. The invention is further applicable to fuel injectors incorporating such nozzles. This invention also relates to methods of making such nozzles, as well as methods of making fuel injectors incorporating such nozzles. The invention further relates to methods of using nozzles and fuel injectors in vehicles.

### BACKGROUND

There are three basic types of fuel injector systems. Those that use port fuel injection (PFI), gasoline direct injection (GDI), and direct injection (DI). While PFI and GDI use gasoline as the fuel, DI uses diesel fuel. Efforts continue to further develop fuel injector nozzles and fuel injection systems containing the same so as to potentially increase fuel efficiency and reduce hazardous emissions of internal combustion engines, as well as reduce the overall energy requirements of a vehicle comprising an internal combustion engine.

### SUMMARY OF THE INVENTION

The present invention is directed to fuel injector nozzles. In one exemplary embodiment, the fuel injector nozzle comprises: an inlet face; an outlet face opposite the inlet face; and at least one nozzle through-hole comprising at least one inlet opening on the inlet face connected to at least one outlet opening on the outlet face by a cavity defined by an interior surface, wherein the outlet face comprises at least one outlet face structure extending from a portion of the outlet face.

In another exemplary embodiment, the fuel injector nozzle comprises: an inlet face; an outlet face opposite the inlet face; and at least one nozzle through-hole comprising at least one inlet opening on the inlet face connected to at least one outlet opening on the outlet face by a cavity defined by an interior surface, wherein the outlet face comprises anti-fouling structure on an exposed surface thereof.

The present invention is further directed to fuel injectors. In one exemplary embodiment, the fuel injector comprises any one of the herein-disclosed nozzles of the present invention.

The present invention is even further directed to fuel injection systems. In one exemplary embodiment, the fuel injection system comprises any one of the herein-disclosed nozzles or fuel injectors of the present invention.

The present invention is also directed to methods of making nozzles. In one exemplary embodiment, the method of making a nozzle of the present invention comprises making any of the herein-described nozzles.

In another exemplary embodiment, the method of making a nozzle of the present invention comprises providing a nozzle perform comprising nozzle material, and at least one cavity for forming at least one nozzle through-hole; and removing nozzle material so as to form the at least one cavity into at least one nozzle through-hole, and to form at least one outlet face structure extending from a portion of an outlet face of the nozzle.

The present invention is also directed to methods of making fuel injectors. In one exemplary embodiment, the method of making a fuel injector comprises incorporating any one of the herein-described nozzles into the fuel injector.

The present invention is also directed to methods of making fuel injection systems of a vehicle. In one exemplary embodiment, the method of making a fuel injection system of a vehicle comprises incorporating any one of the herein-described nozzles or fuel injectors into the fuel injection system.

### BRIEF DESCRIPTION OF DRAWINGS

The invention may be more completely understood and appreciated in consideration of the following detailed description of various embodiments of the invention in connection with the accompanying drawings, in which:

FIG. 1 is a side view of an exemplary nozzle of the present invention;

FIG. 2 is a cross-sectional view of the exemplary nozzle shown in FIG. 1;

FIG. 3 is a side view of another exemplary nozzle of the present invention;

FIGS. 4-5 are perspective views of other exemplary nozzles of the present invention;

FIG. 6-9 are cross-sectional views of other exemplary nozzles of the present invention;

FIGS. 10-12 are magnified perspective views of exemplary anti-fouling microstructures suitable for use on the nozzles of the present invention;

FIG. 13 is a schematic of an exemplary fuel injector system of the present invention;

FIG. 14 is a cross-sectional view of an exemplary method step wherein nozzle material is removed from a nozzle using a material-removing tool;

FIG. 15 is a perspective view of an exemplary material-removing tool suitable for use in the material removal step shown in FIG. 14;

FIGS. 16a-e depict cross-sectional views of exemplary material-removing tools suitable for use in the material removal step shown in FIG. 14;

FIGS. 17a-e depict cross-sectional views of exemplary outlet surface features/profiles formed using the material-removing tools shown in FIGS. 16a-e; and

FIG. 18 is a perspective view of another exemplary material-removing tool suitable for use in the material removal step shown in FIG. 14.

In the specification, a same reference numeral used in multiple figures refers to the same or similar elements having the same or similar properties and functionalities.

### DETAILED DESCRIPTION

The disclosed nozzles represent improvements to nozzles disclosed in (1) International Patent Application Publication WO2011/014607, which published on Feb. 3, 2011, and (2) International Patent Application Serial No. US2012/023624 (3M Docket No. 67266W0003 entitled “Nozzle and Method of Making Same”) filed on Feb. 2, 2012, the subject matter and disclosure of both of which are herein incorporated by reference in their entirety. The disclosed nozzles provide one or more advantages over prior nozzles as discussed herein. For example, the disclosed nozzles can advantageously be incorporated into fuel injector systems to improve fuel efficiency. The disclosed nozzles can be fabricated using multiphoton, such as two photon, processes like those disclosed in International Patent Application Publication WO2011/014607 and International Patent Application Serial No. US2012/023624. In particular, multiphoton processes can be used to fabricate various microstructures, which can at least include one or more hole forming features. Such hole forming features can, in turn, be used as molds to fabricate holes for use in nozzles or other applications.

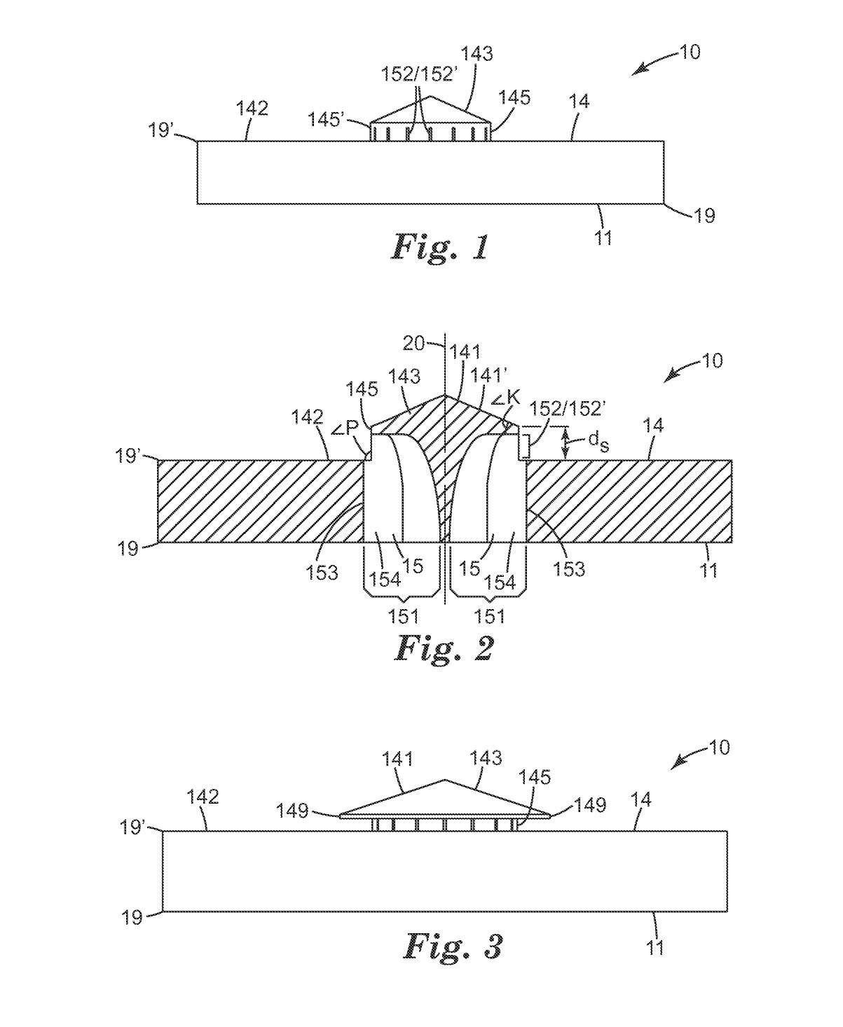

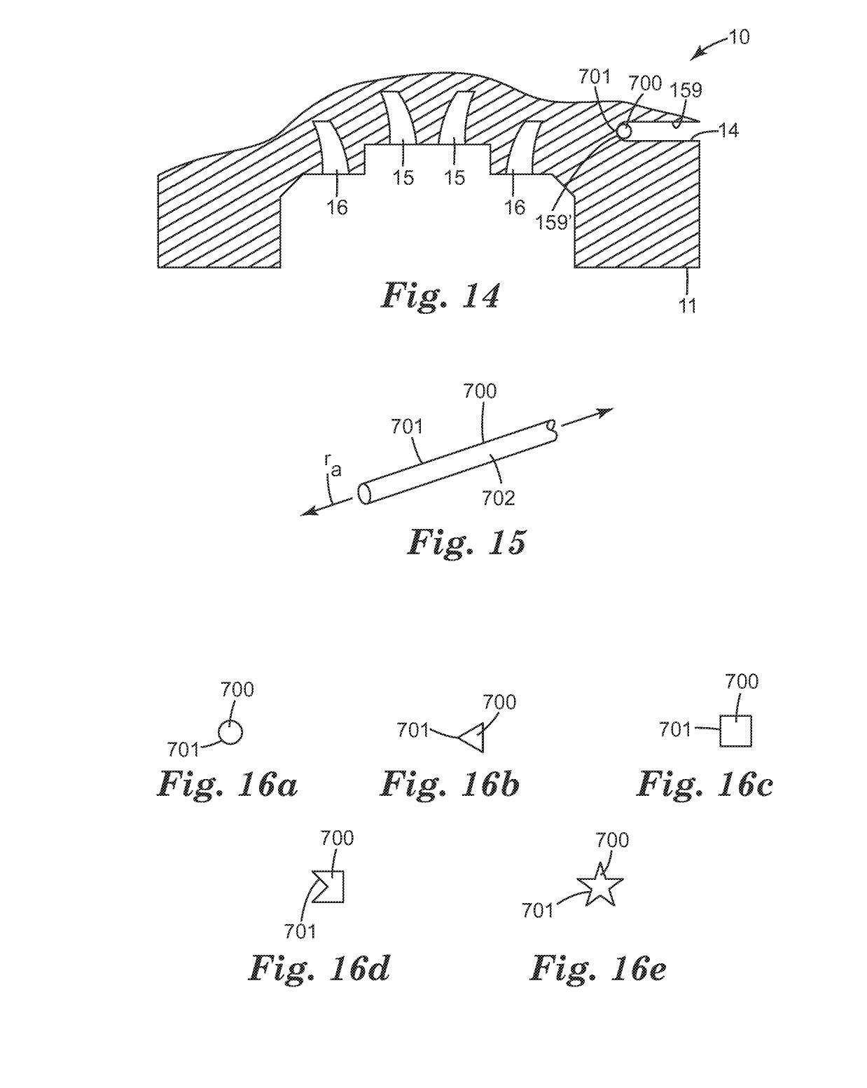

It should be understood that the term “nozzle” may have a number of different meanings in the art. In some specific references, the term nozzle has a broad definition. For example, U.S. Patent Publication No. 2009/0308953 A1 (Palestrant et al.), discloses an “atomizing nozzle” which includes a number of elements, including an occluder chamber 50. This differs from the understanding and definition of nozzle put forth herewith. For example, the nozzle of the current description would correspond generally to the orifice insert 24 of Palestrant et al. In general, the nozzle of the current description can be understood as the final tapered portion of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle . . . ”—see col. 4, lines 26-27 of Ogihara et al.). The current definition and understanding of the term “nozzle” as used herein would relate, e.g., to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1(II)). The above-defined understanding should be understood when the term “nozzle” is referred to throughout the remainder of the description and claims.

FIGS. 1-9 depict various views of exemplary nozzles 10 of the present invention. As shown in FIGS. 1-9, nozzles 10 comprise a three-dimensional outlet face 14. Typically, nozzles 10 comprise a “non-coined” three-dimensional outlet face 14. As used herein, the term “non-coined” refers to outlet face 14 of nozzle 10 not being formed by a deformation process like, for example, a coining or stamping operation, or at least the outlet face 14 having an outlet face structure 143 that is non-coined. As discussed further below, outlet face 14 of nozzle 10 may be formed by, for example, a material deposition process (e.g., by electro plate deposition) followed by a material removal process (e.g., using an electric discharge machining or EDM tool).

As shown in FIGS. 1-9, nozzles 10 of the present invention may further comprise a number of optional, additional features. Suitable optional, additional features include, but are not limited to, one or more overlapping outlet surface portions 149, one or more anti-coking microstructures 150 positioned along any portion of outlet face 14, and one or more fluid impingement structures along any portion of outlet face 14.

As shown in FIGS. 1-9, nozzles 10 of the present invention may comprise nozzle through-holes 15, wherein each nozzle through-hole 15 independently comprises the following features: (i) an inlet opening 151 size and shape, (ii) an outlet opening 152 size and shape, and (iii) an internal surface 154 profile that may include one or more curved sections 157, one or more linear sections 158, or a combination of one or more curved sections 157 and one or more linear sections 158. Selection of these features for each independent nozzle through-hole 15 enables nozzle 10 to provide (1) substantially equal fluid flow through nozzle through-holes 15, (2) variable fluid flow through nozzle through-holes 15 (i.e., fluid flow that is not the same from one nozzle through-holes 15 to another), (3) single- or multi-directional fluid streams exiting nozzle through-holes 15, (4) linear and/or curved fluid streams exiting nozzle through-holes 15, and (5) parallel and/or divergent and/or parallel followed by divergent fluid streams exiting nozzle through-holes 15.

In some embodiments, at least one of nozzle through-holes 15 has an inlet opening 151 axis of flow, a cavity 153 axis of flow and an outlet opening 152 axis of flow, and at least one axis of flow is different from at least one other axis of flow. As used herein, the “axis of flow” is defined as the central axis of a stream of fuel as the fuel flows into, through or out of nozzle through-hole 15. In the case of a nozzle through-hole 15 having multiple inlet openings 151, multiple outlet openings 152 or both, the nozzle through-hole 15 can have a different axis of flow corresponding to each of the multiple openings 151/152.

In some embodiments, inlet opening 151 axis of flow may be different from outlet opening 152 axis of flow. In other embodiments, each of inlet opening 151 axis of flow, cavity 153 axis of flow and outlet opening 152 axis of flow are different from one another. In other embodiments, nozzle through-hole 15 has a cavity 153 that is operatively adapted (e.g., dimensioned, configured or otherwise designed) such that fuel flowing therethrough has an axis of flow that is curved.

Examples of factors that contribute to such differences in axis of flow may include, but are not be limited to, any combination of: (1) a different angle between (i) cavity 153 and (ii) inlet face 11 and/or outlet face 14, (2) inlet openings 151 and/or cavities 153 and/or outlet openings 152 not being aligned or parallel to each other, or aligned along different directions, or parallel but not aligned, or intersecting but not aligned, and/or (3) any other conceivable geometric relationship two or three non-aligned line segments could have.

The disclosed nozzles 10 may comprise (or consist essentially of or consist of) any one of the disclosed nozzle features or any combination of two or more of the disclosed nozzle features. In addition, although not shown in the figures and/or described in detail herein, the nozzles 10 of the present invention may further comprise one or more nozzle features disclosed in (1) U.S. Provisional Patent Application Ser. No. 61/678,356 (3M Docket No. 69910US002 entitled “Targeting of Fuel Output by Off-Axis Directing of Nozzle Output Streams”) filed on Aug. 1, 2012, (2) U.S. Provisional Patent Application Ser. No. 61/678,330 (3M Docket No. 69911US002 entitled “Fuel Injector Nozzles with at Least One Multiple Inlet Port and/or Multiple Outlet Port”) filed on Aug. 1, 2012, (3) U.S. Provisional Patent Application Ser. No. 61/678,305 (3M Docket No. 69912US002 entitled “Fuel Injectors with Improved Coefficient of Fuel Discharge”) filed on Aug. 1, 2012, and (4) U.S. Provisional Patent Application Ser. No. 61/678,288 (3M Docket No. 69913US002 entitled “Fuel Injectors with Non-Coined Three-dimensional Nozzle Inlet Face”) filed on Aug. 1, 2012, the subject matter and disclosure of each of which is herein incorporated by reference in its entirety.

The disclosed nozzles 10 may be formed using any method as long as the resulting outlet face 14 of the nozzle 10 has outlet face 14 features as described herein. Although the methods of making nozzles 10 of the present invention are not limited to methods disclosed in International Patent Application Serial No. US2012/023624, nozzles 10 of the present invention may be formed using methods steps disclosed in International Patent Application Serial No. US2012/023624 in combination with method steps disclosed herein. See, in particular, the method steps described in reference to FIGS. 1A-1M of International Patent Application Serial No. US2012/023624.

### ADDITIONAL EMBODIMENTS

### Nozzle Embodiments

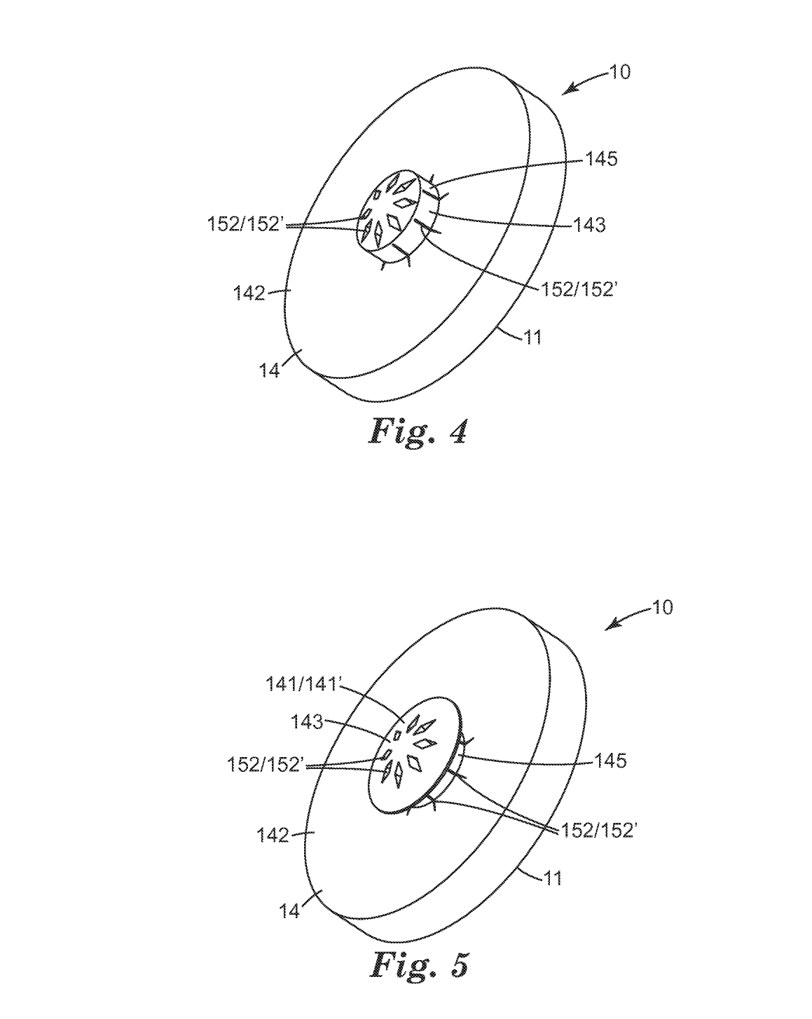

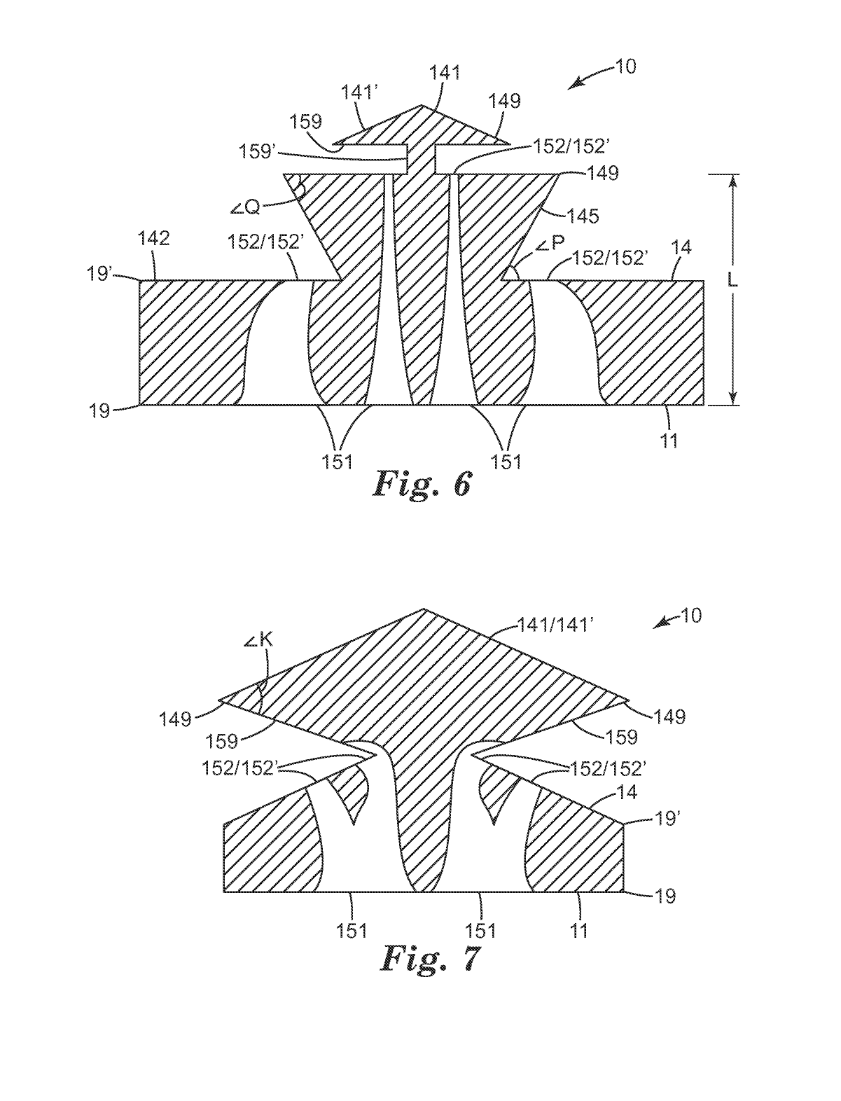

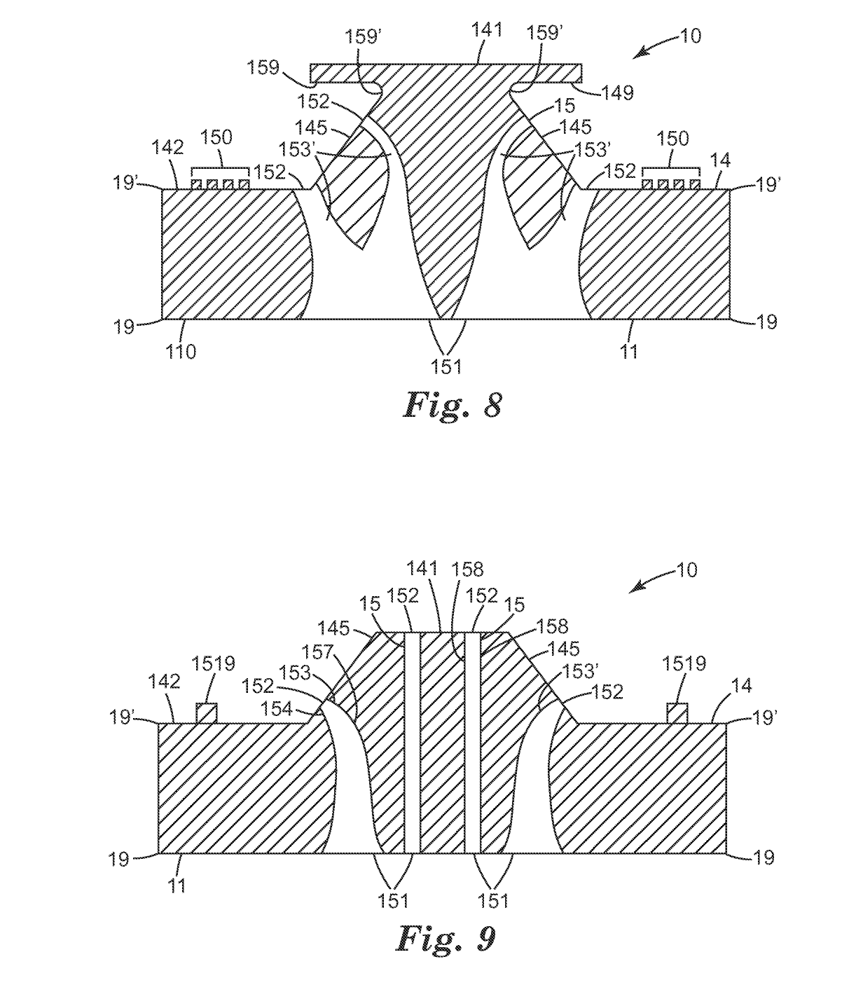

1. A fuel injector nozzle 10 comprising: an inlet face 11, with an inlet face outer periphery 19; an outlet face 14 opposite said inlet face 11, with an outlet face outer periphery 19′; and at least one nozzle through-hole 15 comprising at least one inlet opening 151 on said inlet face 11 connected to at least one outlet opening 152 on said outlet face 14 by a hollow cavity 153 defined by an interior surface 154, wherein said outlet face 14 comprises at least one outlet face structure 143 extending outward or upward from a portion of said outlet face 14. As shown in FIGS. 1-2, for example, inlet face outer periphery 19 and outlet face outer periphery 19′ extend an equal distance from a centrally located normal line 20 extending perpendicularly through nozzle 10. However, it should be understood that in other embodiments, each of inlet face outer periphery 19 and outlet face outer periphery 19′ may extend different distances from centrally located normal line 20 (e.g., a portion or all of outlet face outer periphery 19′ may extend a greater distance from centrally located normal line 20 compared to a distance of a portion of all of inlet face outer periphery 19 from centrally located normal line 20).
2. The nozzle 10 of embodiment 1, wherein said at least one outlet face structure 143 comprises a side surface 145 of an outwardly- or upwardly-extending (e.g., vertically-extending) portion 145′ (e.g., a wall), and said outlet face 14 comprises a base surface 142 located at the base of or otherwise adjacent to said side surface 145 such that said side surface 145 forms a first angle P with said base surface 142.
3. The nozzle 10 of embodiment 2, wherein said first angle P is in the range of from about 15° to about 165°, or any range therebetween, in unit increments of one degree (e.g., about 16° to about 165°, about 15° to about 164°, about 16° to about 164°, about 25° to about 125°, about 30° to about 90°, about 45° to about 135°, etc.), or any angle within the range, in unit increments of one degree (e.g., about 30°, 45°, 60°, 75°, 90°, etc.).
4. The nozzle 10 of embodiment 2 or 3, wherein said first angle P is in the ranges of from about 45° to about 135°.
5. The nozzle 10 of any one of embodiments 2 to 4, wherein said first angle P is about 90°.
6. The nozzle 10 of any one of embodiments 2 to 5, wherein said at least one outlet face structure 143 comprises an upper portion 141′, which is typically an exposed surface 141, and is located outward from or above said base surface 142 by a distance dₛ. Typically, dₛ is greater than about 200 microns (μm) and up to about 2500 μm (or any length between 200 μm and 2500 μm, or an range of lengths between 200 μm and 2500 μm, in increments of 1.0 μm).
7. The nozzle 10 of embodiment 6, wherein at least a portion of an outlet opening periphery 152′, of at least one outlet opening 152 of said at least one or more nozzle through-holes 15, is positioned along or otherwise on said upper portion 141′ of said outlet face structure 143. See, for example, outlet opening peripheries 152′ of outlet openings 152 of nozzle through-holes 15 of nozzle 10 shown in FIG. 4.
8. The nozzle 10 of any one of embodiments 2 to 7, wherein said at least one outlet face structure 143 comprises at least one or more overlapping or overhanging portions 149 extending out from said side surface 145 so as to be located a distance dₛ above a portion of said base surface 142. As discussed above, typically, dₛ is greater than about 200 microns (μm) and up to about 2500 μm (or any length between 200 μm and 2500 μm, or an range of lengths between 200 μm and 2500 μm, in increments of 1.0 μm). See, for example, nozzle 10 shown in FIG. 3.
9. The nozzle 10 of any one of embodiments 1 to 8, wherein at least one outlet opening 152′ of said at least one or more nozzle through-holes 15 is positioned on or at least proximate said at least one outlet face structure 143. See, for example, outlet opening peripheries 152′ of outlet openings 152 of nozzle through-holes 15 of nozzles 10 shown in FIGS. 1-6.
10. The nozzle 10 of any one of embodiments 1 to 9, wherein at least one outlet opening 152′ of said at least one or more nozzle through-holes 15 is operatively adapted (i.e., dimensioned, configured or otherwise designed) to direct fuel (e.g., in the form of a stream) (not shown) exiting said at least one outlet opening 152 so as to contact or impact upon said at least one outlet face structure 143 at an obtuse, acute or right angle. In this way, the exiting fuel can be broken-up into smaller droplets, directed to a particular location or space away from the outlet face structure 143 (i.e., out from the nozzle outlet face 152), or both. In this way, the exiting fuel may also be directed to and reflected off of a portion of the base surface 142 of the outlet face 14, after impacting the outlet face structure 143. The exiting fuel may also be reflected back and forth between one or more outlet face structures 143 and the base surface 142 of the outlet face 14. See, for example, outlet openings 152 of nozzle through-holes 15 of nozzles 10 shown in FIG. 6.
11. The nozzle 10 of any one of embodiments 1 to 10, wherein at least a portion of an outlet opening periphery 152′, of at least one outlet opening 152 of said at least one or more nozzle through-holes 15, is positioned along or otherwise on a portion of said at least one outlet face structure 143. See, for example, outlet opening peripheries 152′ of outlet openings 152 of nozzle through-holes 15 of nozzles 10 shown in FIGS. 1-6.
12. The nozzle 10 of any one of embodiments 2 to 11, wherein at least a portion of an outlet opening periphery 152′, of at least one outlet opening 152 of said at least one or more nozzle through-holes 15, is positioned along or otherwise on said side surface 145 of said outlet face structure 143. See, for example, outlet opening peripheries 152′ of outlet openings 152 of nozzle through-holes 15 of nozzles 10 shown in FIGS. 1-4.
13. The nozzle 10 of any one of embodiments 7 to 12, wherein at least a portion of an outlet opening periphery 152′, of at least one outlet opening 152 of said at least one or more nozzle through-holes 15, is positioned along or otherwise on said at least one or more overlapping or overhanging portions 149. See, for example, outlet opening peripheries 152′ of outlet openings 152 of nozzle through-holes 15 of nozzles 10 shown in FIG. 7.
14. The nozzle 10 of any one of embodiments 7 to 13, wherein at least one outlet opening 152 of said at least one or more nozzle through-holes 15 is at least partially covered by said at least one or more overlapping or overhanging portions 149 of said outlet face structure 143. In this way, the fuel (not shown) exiting the outlet opening 152 can impact the overhanging portion(s) 149 and be broken-up into smaller droplets by being reflected back and forth between the overhanging portion(s) 149 and the underlying base surface 142 of the outlet face 14, one or multiple times, and directed to a particular location or space away from the outlet face structure 143 (i.e., out from the nozzle outlet face 152). See, for example, outlet openings 152 of nozzle through-holes 15 of nozzles 10 shown in FIGS. 6-7.
15. The nozzle 10 of any one of embodiments 7 to 14, wherein at least one outlet opening 152 of said at least one or more nozzle through-holes 15 is completely covered by said at least one or more overlapping or overhanging portions 149 of said outlet face structure 14. See, for example, outlet openings 152 of nozzle through-holes 15 of nozzles 10 shown in FIGS. 6-7.
16. The nozzle 10 of any one of embodiments 7 to 15, wherein at least one overhanging portion 149 comprises an upper overhang surface 141 and a lower overhang surface 159, and said upper and lower overhang surfaces 141/159 form an angle K therebetween.
17. The nozzle 10 of embodiment 16, wherein the angle K between said upper and lower overhang surfaces 141/159 is in the ranges of from about 10° to less than about 90°, or any range therebetween, in unit increments of one degree, or any angle within the range, in unit increments of one degree.
18. The nozzle 10 of embodiment 16 or 17, wherein the angle K between said upper and lower overhang surfaces 141/159 is about 45°.
19. The nozzle 10 of any one of embodiments 16 to 18, wherein said at least one outlet face structure 143 comprises at least one or more intermediate portions 159′ between said upper overhang surface 141 (and said lower overhang surface 159) and said base surface 142. See, for example, nozzles 10 shown in FIGS. 6-8.
20. The nozzle 10 of embodiment 19, wherein said at least one intermediate portion 159′ has a single curved profile. See, for example, nozzle 10 shown in FIG. 8.

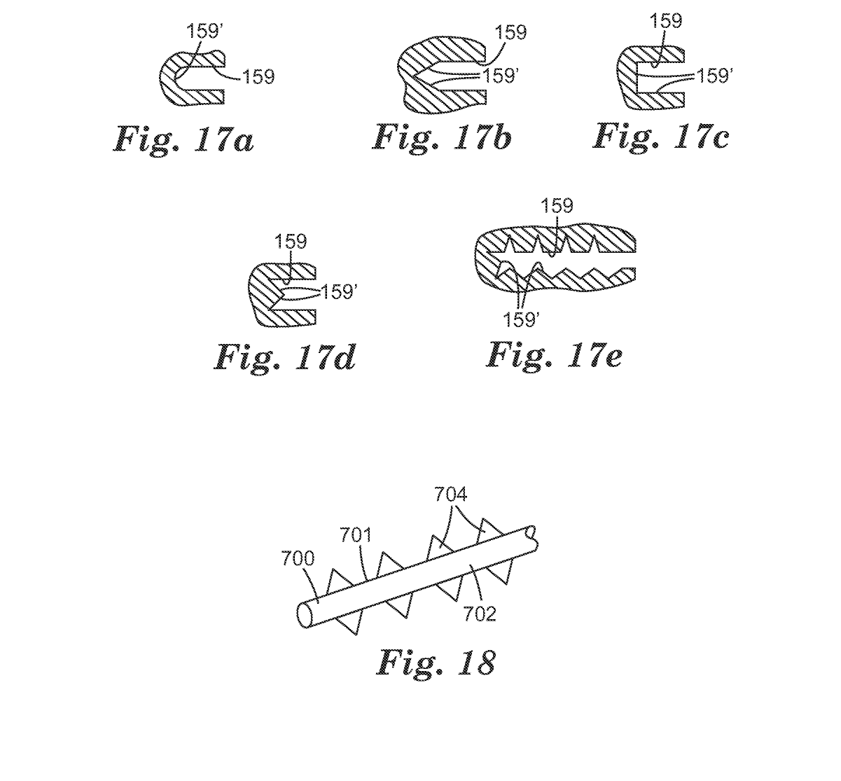

21. The nozzle 10 of embodiment 20, wherein said at least one intermediate portion 159′ comprises two or more profiles (e.g., two intermediate surface portions 159′ that are not within the same curved surface, such as, for example, two or more adjacent, relatively flat surface portions 159′ positioned at an angular relationship to one another). See, for example, sample intermediate portions 159′ shown in FIGS. 17a-e.

22. The nozzle 10 of any one of embodiments 16 to 21, wherein (at least a portion of, or all of) said upper and lower overhang surfaces 141/159 are substantially parallel to one another. See, for example, nozzle 10 shown in FIG. 8.
23. The nozzle 10 of any one of embodiments 14 to 22, wherein at least a portion of an outlet opening perimeter 152′ of said outlet opening 152 of each said nozzle through-hole 15 extends along said overhanging portion 149 of said outlet face structure 143.
24. The nozzle 10 of any one of embodiments 16 to 23, wherein at least a portion of an outlet opening perimeter 152′ of said outlet opening 152 of each of a set of said nozzle through-hole 15 is on said upper overhang surface 141.
25. The nozzle 10 of any one of embodiments 16 to 24, wherein at least a portion of an outlet opening perimeter 152′ of said outlet opening 152 of each of a set of said nozzle through-hole 15 is on said lower overhang surface 159.
26. The nozzle 10 of any one of embodiments 19 to 25, wherein at least a portion of an outlet opening perimeter 152′ of said outlet opening 152 of each of a set of said nozzle through-hole 15 is on said intermediate portion 159′.
27. The nozzle 10 of any one of embodiments 8 to 26, wherein said at least one overhanging portion 149 comprises at least two overhanging portions 149.
28. The nozzle 10 of any one of embodiments 8 to 27, wherein at least one outlet opening 152 of each of a set of said nozzle through-hole 15 is not covered by said at least one overhanging portion 149.
29. The nozzle 10 of any one of embodiments 2 to 28, wherein said base surface 142 is flat or otherwise planar.
30. The nozzle 10 of embodiment 29, wherein said side surface 145 of said outlet face structure 143 forms (i) a first angle P with said base surface 142 in the range of from about 90° to less than about 165°, or any range therebetween, in unit increments of one degree, or any angle within the range, in unit increments of one degree, and (ii) a second angle Q with an upper surface 141 of said upper portion 141′ of said outlet face structure 143 in the range of greater than about 195° to less than about 345°, or any range therebetween, in unit increments of one degree, or any angle within the range, in unit increments of one degree.
31. The nozzle 10 of embodiment 29 or 30, wherein said side surface 145 forms (i) a first angle P with said base surface 142 of about 90°, and (ii) a second angle Q with said upper surface 141 in the range of from about 225° to about 270°, or about 270°.
32. The nozzle 10 of any one of embodiments 29 to 31, wherein said side surface 145 has a relatively flat, cylindrical or truncated cone surface profile extending between said base surface 142 and said upper surface 141.

33. The nozzle 10 of any one of embodiments 29 to 32, wherein all or a portion of the perimeter 152′ of at least one outlet opening 152 of at least one, a plurality, or each said nozzle through-hole 15 is on said side surface 145 of said outlet face structure 143.

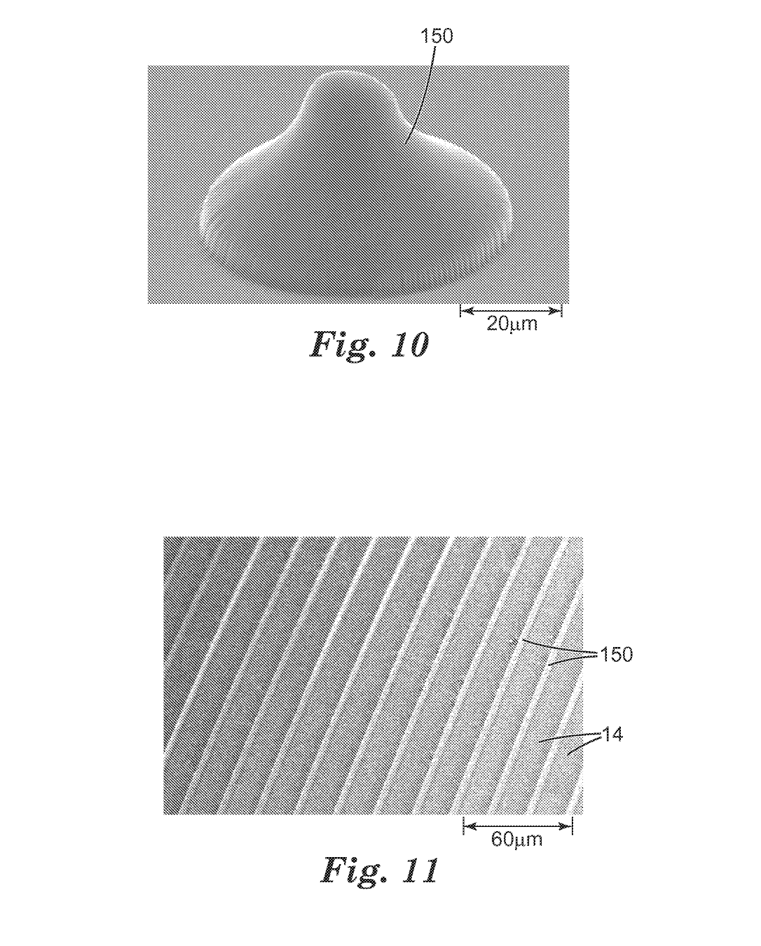

34. The nozzle 10 of any one of embodiments 29 to 33, wherein all or a portion of the perimeter 152′ of at least one outlet opening 152 of at least one, a plurality, or each said nozzle through-hole 15 is on said base surface 142 of said outlet face 14.
35. The nozzle 10 of any one of embodiments 29 to 33, wherein all or a portion of the perimeter 152′ of at least one outlet opening 152 of at least one, a plurality, or each nozzle through-hole 15 is on said upper surface 141.
36. The nozzle 10 of any one of embodiments 1 to 35, wherein at least one or more (e.g., from about 2 to about 24) of said nozzle through-holes 15 comprises at least two or more (e.g., from about 2 to about 24) outlet openings 152. Two or more outlet openings 152 can be used to form rows, columns, or both rows and columns of outlet openings 152 along the side surface 145 of the outlet face structure 143. See, for example, nozzles 10 shown in FIGS. 7-8.
37. The nozzle 10 of any one of embodiments 1 to 36, further comprising anti-fouling (e.g., anti-coking) structures 150 (e.g., microstructures, nanostructures, or both) on an exposed surface 142/145/141/159/159′ of said outlet face 14. See, for example, nozzle 10 shown in FIG. 8. See also, exemplary anti-fouling (e.g., anti-coking) structures 150 shown in FIGS. 10-12.
38. The nozzle 10 of any one of embodiments 1 to 36, wherein said at least one outlet face structure 143 further comprises anti-fouling (e.g., anti-coking) structures 150 (e.g., microstructures, nanostructures, or both) on an exposed surface 145/141/159/159′ of said outlet face structure 143.
39. The nozzle 10 of any one of embodiments 8 to 36, wherein an exposed surface 141/159/159′ of each or at least one of said overhanging portion 149 of said outlet face structure 143 further comprises anti-fouling (e.g., anti-coking) structures 150 (e.g., microstructure, nanostructure, or both) thereon.
40. The nozzle 10 of embodiment 1, wherein said at least one outlet face structure 143 is an anti-fouling (e.g., anti-coking) structure 150 (e.g., microstructure, nanostructure, or both) on an exposed surface 142/145/141/159/159′ of said outlet face 14.
41. A fuel injector nozzle 10 comprising: an inlet face 11; an outlet face 14 opposite said inlet face 11; and at least one nozzle through-hole 15 comprising at least one inlet opening 151 on said inlet face 11 connected to at least one outlet opening 152 on said outlet face 14 by a cavity 153 defined by an interior surface 154, wherein said outlet face 14 comprises anti-fouling (e.g., anti-coking) structures 150 (e.g., microstructure, nanostructure, or both) on an exposed surface thereof.

42. The nozzle 10 of any one of embodiments 37 to 41, wherein said anti-fouling structures 150 comprises surface topographical features having a maximum height above, or a maximum depth into, said outlet face 14 of up to about 500 micrometers (m).

43. The nozzle 10 of any one of embodiments 37 to 42, wherein said anti-fouling structures 150 comprises surface topographical features having a minimum height above, or a minimum depth into, said outlet face 14 of at least about 2 micrometers (m).
44. The nozzle 10 of any one of embodiments 37 to 43, wherein said anti-fouling structures 150 comprise surface topographical features having at least one, or any combination, of a conical shape, cylindrical shape, truncated cone shape, dome shape, pyramidal shape, hemispherical shape, prismatic shape, bread loaf shape, or any other shape.
45. The nozzle 10 of any one of embodiments 1 to 44, wherein the interior surface 154 of the cavity 153 of at least one said nozzle through-hole 15 comprises multiple cavity passages 153′ extending from the interior surface 154 (a) along a length of the cavity 153, (b) adjacent the outlet opening 152 of said nozzle through-hole 15, or (c) both (a) and (b).
46. The nozzle 10 of embodiment 45, wherein said multiple cavity appendages 153′ extend from the interior surface 154 along said cavity 153 a length greater than about 10% of a maximum overall length L of said cavity 153.
47. The nozzle 10 of any one of embodiments 1 to 46, wherein at least one inlet opening 151 and at least one outlet opening 152 for at least one nozzle through-hole 15 has an inlet opening 151 and an outlet opening 152 with a similar shape or a different shape.
48. The nozzle 10 of any one of embodiments 1 to 47, wherein said inlet face 11 has a total inlet opening 151 area that is greater than a total outlet opening 152 area of said outlet face 14.
49. The nozzle 10 of any one of embodiments 1 to 48, wherein said nozzle 10 has an overall ratio of total inlet opening 151 area to total outlet opening 152 area in the range of from greater than 1.0 to about 2500 or any number or range therebetween (e.g., from about 1.0 to about 1000, from about 2 to about 2000, from about 10 to about 1000, and from about 40 to about 500), in unit increments of one, or any ratio within the range, in unit increments of one.
50. The nozzle 10 of any one of embodiments 1 to 49, wherein said nozzle 10 has an overall ratio of total inlet opening 151 area to total outlet opening 152 area in the range of from greater than 1.2 to about 500, or any range therebetween (e.g., from 1.2 to about 250, from about 2 to about 22, from about 2 to about 22, and from about 4 to about 12), in unit increments of one, or any ratio within the range, in unit increments of one.
51. The nozzle 10 of any one of embodiments 1 to 49, wherein said nozzle 10 has an overall ratio of total inlet opening 151 area to total outlet opening 152 area of greater than 30 (or any number or range between 30 and 2500, e.g., from about 40 to 500, in unit increments of one, or any ratio within the range, in unit increments of one).
52. The nozzle 10 of any one of embodiments 1 to 49 and 51, wherein said nozzle 10 has an overall ratio of total inlet opening 151 cross-sectional area to total outlet opening 152 cross-sectional area in the range of from about 1.2 to about 250, or any range therebetween, in unit increments of one, or any ratio within the range, in unit increments of one.
53. The nozzle 10 of any one of embodiments 1 to 52, wherein each inlet opening 151 has a major dimension (e.g., a diameter) of less than about 500 microns (or less than about 400 microns, or less than about 300 microns, or less than about 200 microns, or less than about 160 microns, or less than about 100 microns) (or any major dimension/diameter between about 10 microns and 500 microns in increments of 1.0 micron, e.g., 10, 11, 12, etc. microns). As used herein, the term “major dimension” represents the largest distance across a given inlet opening 151 (or a given outlet opening 152).
54. The nozzle 10 of any one of embodiments 1 to 53, wherein each outlet opening 152 has a major dimension (e.g., a diameter) of less than about 300 microns (or less than about 200 microns, or less than about 100 microns, or less than about 50 microns, or less than about 20 microns) (or any major dimension between about 10 microns and 300 microns in increments of 1.0 micron, e.g., 10, 11, 12, etc. microns).
55. The nozzle 10 of any one of embodiments 1 to 54, wherein said nozzle 10 comprises a metallic material, an inorganic non-metallic material (e.g., a ceramic selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof), or a combination thereof.
56. The nozzle 10 of any one of embodiments 1 to 55, wherein the nozzle 10 comprises a monolithic structure. As used herein, the term “monolithic” refers to a nozzle 10 having a single, integrally formed structure, as oppose to multiple parts or components being combined with one another to form a nozzle.

### Fuel Injector Embodiments

57. A fuel injector 101 comprising the nozzle 10 of any one of embodiments 1 to 56.

### Fuel Injector Systems Embodiments

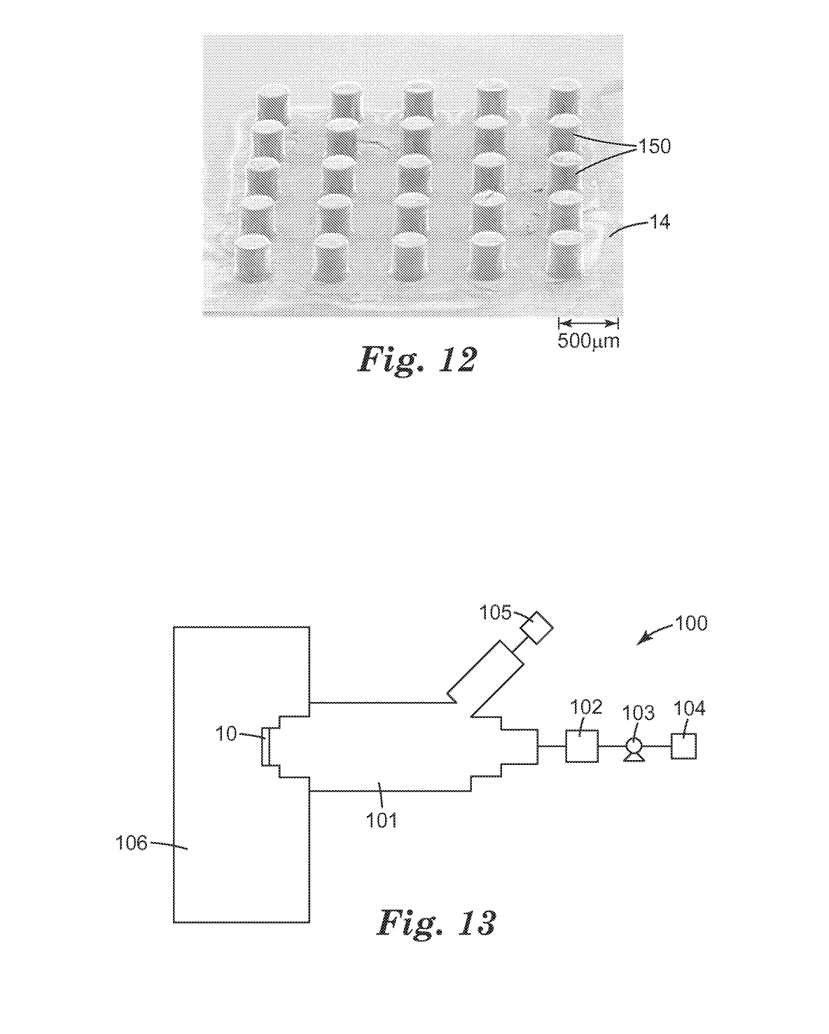

58. A fuel injection system 100 of an internal combustion engine 106 (e.g., a vehicle engine, power generator, etc.) comprising the nozzle 10 of any one of embodiments 1 to 57. (The fuel injector system 100 comprising, inter alia, fuel injector 101, fuel source/tank 104, fuel pump 103, fuel filter 102, fuel injector electrical source 105, and engine 106 as shown in FIG. 13.)

### Methods of Making Nozzles Embodiments

59. A method of making the nozzle 10 of any one of embodiments 1 to 56, said method comprising: providing a nozzle perform comprising nozzle material, and at least one cavity for forming at least one nozzle through-hole; removing nozzle material so as to form the at least one cavity into at least one nozzle through-hole 15, and to form at least one outlet face structure 143.
60. The method of embodiment 59, wherein said nozzle material removal step comprises opening at least one or both ends of the at least one cavity so as to form at least one or both of the inlet opening 151 and the outlet opening 152 of at least one nozzle through-hole 15.
61. The method of embodiment 59 or 60, wherein said removing step comprises removing desired nozzle material by positioning a material-removing tool 700 (e.g., a cutting edge of a wedge-shaped cutting tool, an electric discharge machining or EDM tool) proximate or in contact with the nozzle perform. A wire electrode or a sinker EDM cutting tool is a preferred material-removing tool 700. See, for example, the removal method step shown in FIG. 14.
62. The method of any one of embodiments 59 to 61, wherein said method further comprises: forming anti-fouling structures 150 on the outlet face 14 of the nozzle 10.
63. The method of embodiment 62, wherein said step of forming anti-fouling structures 150 comprises: fabricating the anti-fouling structures into a nozzle forming microstructured pattern used to form the nozzle pre-form; applying a nozzle-forming material onto the nozzle forming microstructured pattern comprising one or more nozzle through-hole forming features; separating the nozzle-forming material from the nozzle forming microstructured pattern to provide the nozzle 10; and removing nozzle material, as needed, from the nozzle 10 so as to form one or more nozzle through-holes 15 and/or 16.
64. The method of embodiment 63, wherein said fabricating step comprises: forming the anti-fouling structures on a master tool; metalizing the master tool; electroforming the metalized master tool to form an EDM electrode; and burning the EDM electrode into a fuel injector nozzle plate so as to form the nozzle forming microstructured pattern.
65. The method of embodiment 64, wherein said forming step comprises a two-photon polymerization step.
66. The method of embodiment 63, wherein said fabricating step comprises: coating a master tool with a nanoparticle-containing solution prior to metalizing the master tool; metalizing the master tool; electroforming the metalized master tool to form an EDM electrode; and burning the EDM electrode into an injector plate so as to form the nozzle forming microstructured pattern.
67. The method of embodiments 59 to 66, wherein said removing step comprises removing material from the nozzle 10 with a material-removing tool 700 having an outer lead surface 701 (i.e., a lead outer surface 701 along an outer surface 702) of a tool 700, the outer lead surface 701 of the tool 700 providing at least one of the following outlet face features: (1) an overlapping outer surface profile 159/159′ for each overlapping outer surface portion 149, when present, (2) at least one side surface (i.e., vertically-extending wall portion) 145 along the outer face 14, (3) one or more impingement members 1519, (4) anti-coking structures 150, and (5) one or more outlet openings 152. See, for example, FIGS. 14-15.
68. The method of embodiments 59 to 67, wherein said removing step comprises removing material from the nozzle 10 with a material-removing tool 700 having an outer lead surface 701, the outer lead surface 701 of the tool 700 comprising a single continuous surface (e.g., an arc-shaped surface) having a circular cross-sectional configuration (e.g., tool 701 shown in FIGS. 14-15). As shown in FIGS. 16 a-e, tool 700 may have any desired cross-sectional configuration, which results in various outlet surface 14 features including, but not limited to, a desired overlapping outer surface profile 159/159′ for a given overlapping outer surface portion 149 as shown in FIGS. 17a-e, anti-coking microstructures 150 (as shown in FIGS. 10-12), impingement members 1519 as shown in FIG. 9, and other outlet face 14 surface undulations (not shown). In some embodiments, tool 700 may be rotated along its axis, rₐ, to further provide surface features to outlet face 14 (e.g., when tool 700 has a star-shaped cross-sectional configuration, as shown in FIG. 16e, and is rotated along is axis while removing material from nozzle 10, so as to result in an outlet face 14 features shown in FIG. 15e). Further, tool 700 have further comprise one or more tool surface features 704 (as shown in FIG. 18) that may be used (either with or without rotation along its axis, rₐ) to further provide outlet face 14 features on nozzle 10.

### Methods of Making Fuel Injectors Embodiments

69. A method of forming a fuel injector 101, said method comprising incorporating the nozzle 10 of any one of embodiments 1 to 57 into the fuel injector 101.

### Methods of Making Fuel Injection Systems Embodiments

70. A method of forming a fuel injection system 100 (e.g., of an internal combustion engine, such as vehicle 200), said method comprising incorporating the nozzle 10 of any one of embodiments 1 to 56 into the fuel injection system 100.

### Nozzle Pre-Form Embodiments

71. A nozzle pre-form suitable for forming the nozzle 10 of any one of Embodiments 1 to 6 See, for example, other nozzle pre-forms and how the nozzle pre-forms are utilized to form nozzles in FIGS. 1A-1M and the description thereof in International Patent Application Serial No. US2012/023624.

### Microstructured Pattern Embodiments

72. A microstructured pattern suitable for forming the nozzle 10 of any one of embodiments 1 to 56. See, for example, other microstructured patterns and how the microstructured patterns are utilized to form nozzles in FIGS. 1A-1M and the description thereof in International Patent Application Serial No. US2012/023624.

In any of the above embodiments, nozzle 10 may comprise a nozzle plate 10 having a substantially flat configuration typically with at least a portion of inlet face 11 substantially parallel to at least a portion of outlet face 14.

It can be desirable for the thickness of a fuel injector nozzle 10 to be at least about 100 μm, preferably greater than about 200 μm; and less than about 3 mm, preferably less than about 1 mm, more preferably less than about 500 μm (or any thickness or thickness range between about 100 μm and 3 mm in increments of 1 μm). As shown in various figures, it can be desirable for the nozzles to have a thickness that is thinner around the perimeter of the nozzle plate (e.g., the welding area to be welded to the tip of a fuel injector) and thicker in an inner region of the nozzle plate. The pressure of the fuel upstream of the nozzle inlet in the fuel injector (especially with the higher pressures of GDI or DI systems) can cause premature failure or unintended deflection of a nozzle plate that is too thin. As the nozzle plate thickness is increased, however, it becomes increasingly difficult to produce a high quality weld (e.g., laser weld) of the nozzle plate onto the injector body. By making the inner region thicker and the perimeter relatively thinner, the inventive nozzle can be operatively adapted (e.g., dimensioned, configured or otherwise designed) so as to strike a balance of the above needs.

Further, although not shown in the figures, any of the herein-described nozzles 10 may further comprise one or more alignment surface features that enable (1) alignment of nozzle 10 (i.e., in the x-y plane) relative to a fuel injector 101 and (2) rotational alignment/orientation of nozzle 10 (i.e., a proper rotational position within the x-y plane) relative to a fuel injector 101. The one or more alignment surface features aid in positioning nozzle 10 and nozzle through-holes 15 therein so as to be accurately and precisely directed at one or more target location lₜ as discussed above. The one or more alignment surface features on nozzle 10 may be present along inlet face 11, outlet face 14, periphery 19, or any combination of inlet face 11, outlet face 14 and periphery 19. Further, the one or more alignment surface features on nozzle 10 may comprise, but are not limited to, a visual marking, an indentation within nozzle 10, a raised surface portion along nozzle 10, or any combination of such alignment surface features.

It should be understood that although the above-described nozzles, nozzle plates, fuel injectors, fuel injector systems, and methods are described as “comprising” one or more components, features or steps, the above-described nozzles, nozzle plates, fuel injectors, fuel injector systems, and methods may “comprise,” “consists of,” or “consist essentially of” any of the above-described components and/or features and/or steps of the nozzles, nozzle plates, fuel injectors, fuel injector systems, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a nozzle, nozzle plate, fuel injector, fuel injector system, and/or method that “comprises” a list of elements (e.g., components or features or steps) is not necessarily limited to only those elements (or components or features or steps), but may include other elements (or components or features or steps) not expressly listed or inherent to the nozzle, nozzle plate, fuel injector, fuel injector system, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a nozzle, nozzle plate, fuel injector, fuel injector system, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described nozzles, nozzle plates, fuel injectors, fuel injector systems, and/or methods may comprise, consist essentially of, or consist of any of the herein-described components and features, as shown in the figures with or without any additional feature(s) not shown in the figures. In other words, in some embodiments, the nozzles, nozzle plates, fuel injectors, fuel injector systems, and/or methods of the present invention may have any additional feature that is not specifically shown in the figures. In some embodiments, the nozzles, nozzle plates, fuel injectors, fuel injector systems, and/or methods of the present invention do not have any additional features other than those (i.e., some or all) shown in the figures, and such additional features, not shown in the figures, are specifically excluded from the nozzles, nozzle plates, fuel injectors, fuel injector systems, and/or methods.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

Nozzles, similar to exemplary nozzles 10 as shown in FIGS. 1-9, were prepared for use in fuel injector systems, similar to fuel injector system 100.

From the above disclosure of the general principles of the present invention and the preceding detailed description, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof. In addition, it is understood to be within the scope of the present invention that the disclosed and claimed nozzles may be useful in other applications (i.e., not as fuel injector nozzles). Therefore, the scope of the invention may be broadened to include the use of the claimed and disclosed structures for such other applications.

1. A fuel injector nozzle comprising:
an inlet face;
an outlet face opposite said inlet face; and
at least one nozzle through-hole comprising at least one inlet opening on said inlet face connected to at least one outlet opening on said outlet face by a cavity defined by an interior surface,
wherein said fuel injector nozzle is a monolithic structure, with said outlet face being a non-coined three-dimensional outlet face comprising at least one outlet face structure.

2. The nozzle of claim 1, wherein said at least one outlet face structure comprises a side surface, and said outlet face comprises a base surface located adjacent to said side surface such that said side surface forms a first angle with said base surface.

3. The nozzle of claim 2, wherein said first angle is in the ranges of from about 45° to about 135°.

4. The nozzle of claim 2, wherein said first angle is about 90°.

5. The nozzle of claim 4, wherein said at least one outlet face structure comprises at least one overhanging portion extending out from said side surface so as to be located a distance dₛ above a portion of said base surface.

6. The nozzle of claim 5, wherein at least one outlet opening of said at least one nozzle through-hole is operatively adapted to direct fuel exiting said at least one outlet opening so as to impact upon said at least one outlet face structure.

7. The nozzle of claim 6, wherein at least a portion of an outlet opening periphery, of at least one outlet opening of said at least one nozzle through-hole, is on a portion of said at least one outlet face structure.

8. The nozzle of claim 7, wherein at least a portion of an outlet opening periphery, of at least one outlet opening of said at least one nozzle through-hole, is on said side surface of said outlet face structure.

9. The nozzle of claim 2, wherein said base surface is planar.

10. The nozzle of claim 2, wherein said side surface of said outlet face structure forms (i) a first angle with said base surface in the range of from about 90° to less than about 165°, and (ii) a second angle with an upper surface of said outlet face structure in the range of greater than about 195° to less than about 345°.

11. The nozzle of claim 2, wherein a portion of at least one outlet opening of at least one said nozzle through-hole is on said base surface of said outlet face.

12. The nozzle of claim 10, wherein a portion of at least one outlet opening of at least one nozzle through-hole is on said upper surface.

13. The nozzle of claim 1, further comprising anti-fouling structures on an exposed surface of said outlet face.

14. A fuel injection system of an internal combustion engine comprising the nozzle of claim 1.

15. A method of making the nozzle of claim 1, said method comprising:
providing a nozzle perform comprising nozzle material, and at least one cavity for forming at least one nozzle through-hole;
removing nozzle material so as to form the at least one cavity into at least one nozzle through-hole, and to form at least one outlet face structure.

16. The nozzle of claim 2, wherein said at least one outlet face structure comprises at least one overhanging portion extending out from said side surface so as to be located a distance dₛ above a portion of said base surface.

17. The nozzle of claim 1, wherein at least one outlet opening of said at least one nozzle through-hole is operatively adapted to direct fuel exiting said at least one outlet opening so as to impact upon said at least one outlet face structure.

18. The nozzle of claim 1, wherein at least a portion of an outlet opening periphery, of at least one outlet opening of said at least one nozzle through-hole, is on a portion of said at least one outlet face structure.

19. The nozzle of claim 2, wherein at least a portion of an outlet opening periphery, of at least one outlet opening of said at least one nozzle through-hole, is on said side surface of said outlet face structure.

20. The nozzle of claim 11, wherein a portion of at least one outlet opening of at least one nozzle through-hole is on said upper surface.
